(19) United States
(12) Patent Application Publication
(10) Pub. No.: US 2010/0283617 A1
(43) Pub. Date: Nov. 11, 2010

(54) DIAPER ALARM SYSTEM

(76) Inventors: Chih-Ming HUANG, Chu Bei City (TW); Tzu-Ying Wu, ChuBei City (TW)

Correspondence Address: Muncy, Geissler, Olds & Lowe, PLLC, 4000 Legato Road, Suite 310, FAIRFAX, VA, 22033, US

(21) Appl. No.: 12/537,758

(22) Filed: Aug. 7, 2009

(30) Foreign Application Priority Data
May 8, 2009 (TW) 98207950

(51) Int. Cl. G08B 23/00

(52) U.S. Cl. 340/573.5

(57) ABSTRACT

A diaper alarm system, comprising: at least a diaper, and an alarm system. Wherein, in each diaper is provided with a sensor and a transmitter. Said sensor and said transmitter are located inside said diaper, said sensor is printed on a urine-gathering region and an excrement-gathering region inside said diaper, such that the sensor is connected to the transmitter wirelessly, thus said sensor is able to utilize said transmitter to send out detection signals. Said alarm system includes a receiver, which is connected to said transmitter through transmission of telecommunication signals. On receiving a detection signal by said receiver, said alarm system will determine whether to send out an alarm based on said detection signal.

### BACKGROUND OF THE INVENTION

1. Field of the Invention

The present invention relates to a diaper alarm system, and in particular to a diaper alarm system having its sensor printer on a diaper.

2. The Prior Arts

Since newly born infant is not able to control his/her won behavior, as such, diaper is indispensable for almost every newly born infant. However, in applying a diaper to an infant, care must be taken, so that infant can avoid being infected with diaper rash. Since, in case that a newly born infant gets ill, it could be a series burden and drain to the economy of a family.

In general, diaper rash is a result of skin infection caused by moisture in a diaper. The main reasons for this can be attributed to changes of skin PH values, contamination caused by protein in excrement, and secondary infection of bacteria. According to a research report, which shows that for an infant whose diaper utilized changes eight times a day, the infections of diaper rash are not quite often. As such, frequent changes of diapers utilized are important for the following two reasons:

1. Long period exposure to moisture will make skin more liable to be infected with diaper rash; and

2. The longer excrement and urine of an infant stay and mixed together, the longer the enzyme thus produced will harm the skin of an infant. Therefore, the application of diaper of strong absorption capability may facilitate the absorption of urine and excrement on the buttocks of an infant.

In this respect, in particular, the principle of “when it gets wet, change diaper” must be observed, so as to ensure that the infant will not be infected with diaper rash. Summing up the above, in order that a newly born infant not liable to get diaper rash, a large number of diapers have to be changed daily, in addition, the principle of “when it gets wet, change diaper” must be observed, thus for the parents (or kin of the family) or medi-care attendant, this constitutes a great burden, since they have to check from time to time to see if the diaper of an infant is wet. That is not only tedious but also time-consuming. Therefore, this problem must be solved and improved urgently.

Moreover, there exist another kind of persons who are not able to control their own behaviors, such as patients or mentally-retarded elderly persons. Such kind of persons behave just like newly born infants, who require medi-care attendant or medi-care warden to spend large amount of time and effort on checking to see if their diapers are wet. In situations that in a family of a newly born infant there are mentally-retarded elderly persons to be taken care of, then the problem of how to take good care of the newly born infant and mentally-retarded elderly persons more effectively, is a very important task that must be solved urgently.

### SUMMARY OF THE INVENTION

In view of the problems and shortcomings of the prior art, an important objective of the present invention is to provide a diaper alarm system, so as to overcome the problems of the prior art.

A major objective of the present invention is to provide a diaper alarm system, wherein, a sensor is printed onto an inner side of a diaper, so as to reduce the cost of sensor, eliminating the necessity of sterilization, and raising the safety of utilization.

Another objective of the present invention is to provide a diaper alarm system, that can be utilized to monitor to check if the diaper is wet, and that is applicable to users in hospitals, sanatorium, and ordinary households.

A yet another objective of the present invention is to provide a diaper alarm system, that is utilized to reduce the labor cost for manually monitoring and controlling to check if a diaper is wet, and reduce the infections of diaper rashes by patients or infants wearing this kind of diapers.

The present invention provides a diaper alarm system, comprising: at least a diaper, and an alarm system. Wherein, in each diaper is provided with a sensor and a transmitter. The sensor and transmitter are located inside the diaper, the sensor is printed on a urine-gathering region and an excrement-gathering region inside the diaper, such that the sensor is connected to the transmitter wirelessly, thus the sensor is able to utilize the transmitter to send out detection signals. The alarm system includes a receiver, which is connected to the transmitter through the transmission of telecommunication signals. On receiving a detection signal by the receiver, the alarm system will determine whether to send out an alarm based on the detection signal.

To the user located in hospitals, sanatorium, and ordinary households, the diaper alarm system of the present invention can be connected to an alarm system through telecommunication signals transmitted in compliance with a Zigbee short distance wireless communication standard protocol, hereby achieving the objective of reducing labor cost and infections of diaper rashes by patients or infants. Of course, in a hospital or sanatorium, the alarm system can be placed in a medi-care center; or, alternatively, a portable alarm system can be carried manually by a medi-care attendant or a medi-care warden for monitoring the conditions of a diaper at any time. Naturally, parents (or kin of the family) may also utilize such a portable alarm system, so as to be informed to know whether the diaper is wet at any time. In addition, in the diaper alarm system of the present invention, sensor is printed onto the inner side of a diaper, thus significantly reducing the cost of sensor, eliminating the necessity of sterilization, and raising the safety of utilization.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a system block diagram of a diaper alarm system of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

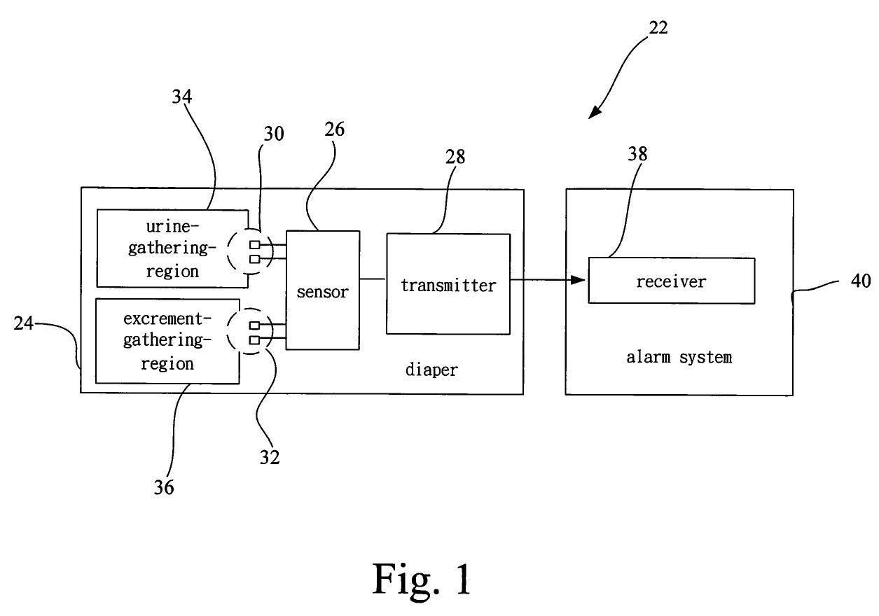

The diaper alarm system 22 provided by the present invention is applicable to users in hospitals, wardrooms in a disable attendance company, sanatorium, and ordinary households. For a more detailed description, refer to FIG. 1 for a system block diagram of a diaper alarm system of the present invention. As shown in FIG. 1, the diaper alarm system 22 includes at least a diaper 24, and an alarm system 38. Each diaper 24 is provided with a sensor 26, and a transmitter 28. In the present embodiment, the sensor 26 is a humidity sensor 26, and that is printed onto a urine-gathering region 34 and an excrement-gathering region 36 inside the diaper 24. The sensor 26 includes a first set of electrodes 30 and a second set of electrodes 32, located respectively in the urine-gathering region 34 and the excrement-gathering region 36. When the occurrence of urine or excrement causes the urine-gathering region 34 and the excrement-gathering region 36 to get wet, and that will activate and turn on the first set of electrodes 30 and the second set of electrodes 32. The sensor 26 is connected to a transmitter 28, such that the sensor 26 is able to make the transmitter send out detection signals. Wherein, the transmitter 28 is a button-type transmitter, and that is capable of supplying power to the sensor 26. In the present embodiment, for the button-type transmitter, a mercury battery is utilized to supply power.

The alarm system 38 includes a receiver 40, that is connected to transmitter 28 wirelessly through telecommunication signals transmission. On receiving the detection signals by the receiver 40, the alarm system 38 will determine whether to send out an alarm based on the detection signal. In the present embodiment, the alarm system 38 is a portable alarm system (alarm), an alarm system in a medi-care center in a hospital, or a computer terminal device having an alarm. The users of alarm system 38 can be a nurse, a medi-care attendant, parents (or kin of the family). Wherein, the transmitter 28 and receiver 40 are connected wirelessly through telecommunication signals transmitted in compliance with a Zigbee short distance wireless communication standard protocol.

When the occurrence of urine or excrement causes the urine-gathering region 34 or the excrement-gathering region 36 to get wet, that will activate and turn on a first set of electrodes 30 and a second set of electrodes 32 in sensing and sending out a detection signal through the transmitter 28. On receiving the detection signals by the receiver 40, the alarm system 38 will determine whether to send out an alarm based on the detection signal.

To the user located in hospitals, sanatorium, and ordinary households, the diaper alarm system 22 of the present invention can be connected to an alarm system 38 through telecommunication signals transmitted in compliance with a Zigbee short distance wireless communication standard protocol, such that it can be used to monitor and control a plurality of infants, mentally-retarded elderly persons, and patients, hereby achieving the objective of reducing labor cost and infections of diaper rashes by patients or infants. Of course, in a hospital or sanatorium, the alarm system 38 can be place in a medi-care center; or, alternatively, the alarm system can be carried manually by a medi-care attendant or a medi-care warden for monitoring and controlling the conditions of a diaper at any time. Naturally, parents (or kin of the family) may also utilize such a portable alarm system 38, so as to be informed to know if the diaper 24 is wet at any time. In addition, in the diaper alarm system 22 of the present invention, the sensor 26 is printed onto the inner side of a diaper 24, thus significantly reducing the cost of sensor, eliminating the necessity of sterilization, and raising the safety of utilization.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A diaper alarm system, comprising:
at least a diaper, each diaper is provided with a sensor and a transmitter, said sensor is printed on a urine-gathering region and an excrement-gathering region inside the diaper, said sensor is connected to said transmitter, such that said is able to utilize said transmitter to send out a detection signal; and
an alarm system, including a receiver, which is connected to said transmitter through transmission of telecommunication signals, on receiving said detection signal by said receiver, said alarm system will determine whether to send out an alarm based on said detection signal.

2. The diaper alarm system as claimed in claim 1, wherein
said alarm system is a portable alarm system.

3. The diaper alarm system as claimed in claim 1, wherein
said alarm system is in a medi-care center in a hospital.

4. The diaper alarm system as claimed in claim 1, wherein
said transmitter and said receiver are connected wirelessly through telecommunication signals transmitted in compliance with a Zigbee short distance wireless communication standard protocol.

5. The diaper alarm system as claimed in claim 1, wherein
said sensor is a humidity sensor.

6. The diaper alarm system as claimed in claim 1, wherein
said sensor includes a first sets of electrodes and a second set of electrodes, and that are located respectively in a urine-gathering region and an excrement-gathering region, when the occurrence of urine or excrement causes said urine-gathering region and said excrement-gathering region to get wet, that will activate and turn on said first set of electrodes and said second set of electrodes, said sensor is able to make said transmitter send out detection signals, on receiving said detection signals by said receiver, said alarm system will determine whether to send out an alarm based on said detection signals.

7. The diaper alarm system as claimed in claim 1, wherein
said transmitter is a button-type transmitter, and that is utilized to supply power to said sensor.

8. The diaper alarm system as claimed in claim 1, wherein
in said button-type transmitter, a mercury battery is utilized to supply power.
